(19) United States
(12) Patent Application Publication
(10) Pub. No.: US 2025/0226630 A1
(43) Pub. Date: Jul. 10, 2025

(54) HOLDER HAVING A MISTAKE-PROOF STRUCTURE AND LIGHTING DEVICE HAVING THE SAME

(71) Applicant: Xiamen PVTECH Co., Ltd., Xiamen (CN)

(72) Inventors: Fuxing Lu, Xiamen (CN); Jinsheng Li, Xiamen (CN)

(73) Assignee: Xiamen PVTECH Co., Ltd., Xiamen (CN)

(21) Appl. No.: 18/985,083

(22) Filed: Dec. 18, 2024

Related U.S. Application Data
(63) Continuation-in-part of application No. 18/633,544, filed on Apr. 12, 2024, now Pat. No. 12,297,983.

(30) Foreign Application Priority Data
Jan. 10, 2024 (CN) 202410038747.X

(51) Int. Cl. H01R 33/08; F21V 19/00; H01R 33/94

(52) U.S. Cl. CPC H01R 33/0854; F21V 19/008; H01R 33/942

(57) ABSTRACT

A holder having a mistake-proof structure includes a holder body, two conductive plates, a rotatable fixing element and an installation fixing element. The holder body has a top hole, a central post, and a central recess. The central post is disposed in the central recess. The conductive plates are disposed in the holder body. The rotational fixing element is rotatably connected to the central post and has an extending portion and two through holes disposed opposite each other. The rotational fixing element is rotatable to align the through holes with the top hole. The installation fixing element passes through the top hole and the through holes.

### CROSS REFERENCE TO RELATED APPLICATIONS

This application is a continuation-in-part of U.S. application Ser. No. 18/633,544, filed on Apr. 12, 2024. The content of the application is incorporated herein by reference.

### BACKGROUND OF THE INVENTION

### 1. Field of the Invention

The present invention relates to a holder, in particular to a holder having a mistake-proof structure. The present invention also relates to the lighting device having the holder.

### 2. Description of the Prior Art

The replaceable light tubes are convenient in use, so these light tubes have been widely utilized in commercial buildings, industrial structures, or residences. However, some of currently available light tubes cannot be installed on installations bases equipped with electronic ballasts or those with preheating functions in inductive ballasts. If these light tubes are erroneously installed on such installation bases, these light tubes may be damaged or result in accidents such as fires. However, the currently available light tubes lack appropriate mistake-proof structures, so users tend to mistakenly install these light tubes on incompatible installation bases.

Additionally, the currently available light tubes lack appropriate safety structures, making these light tubes prone to falling due to earthquakes or other factors. Therefore, the safety and reliability of the currently available light tubes need further improvement.

### SUMMARY OF THE INVENTION

One embodiment of the present invention provides a lighting device having a mistake-proof structure, which includes two holders and a light tube. Each holder includes a holder body, two conductive plates, a rotational fixing element, and an installation fixing element. The conductive plates are disposed in the holder body, and the holder body has a top hole, a central post, and a central recess. The central post is disposed in the central recess, and the rotational fixing element is rotatably connected to the central post, and has an extending portion and two through holes disposed opposite each other. The rotational fixing element is rotatable to align the through holes with the top hole, and the installation fixing element passes through the top hole and the through holes. The light tube electrically connected to the two conductive plates and includes a tube body and two end caps provided at the two ends of the tube body. The end caps are respectively disposed on the two holders, and each of the end caps has an extending space engaged with the extending portion of the rotational fixing element corresponding thereto.

Another embodiment of the present invention provides a holder having a mistake-proof structure, which includes a holder body, two conductive plates, a rotatable fixing element and an installation fixing element. The holder body has a top hole, a central post, and a central recess. The central post is disposed in the central recess. The conductive plates are disposed in the holder body. The rotational fixing element is rotatably connected to the central post and has an extending portion and two through holes disposed opposite each other. The rotational fixing element is rotatable to align the through holes with the top hole. The installation fixing element passes through the top hole and the through holes.

The holder, light tube, lighting device having the mistake-proof structure, installation method and modifying method thereof in accordance with the embodiments of the present invention may have the following advantages:

(1) In one embodiment of the present invention, the lighting device includes two holders and a light tube. Each holder includes a holder body, two conductive plates, a rotational fixing element, and an installation fixing element. The conductive plates are disposed in the holder body, and the holder body has a top hole, a central post, and a central recess. The central post is disposed in the central recess, and the rotational fixing element is rotatably connected to the central post, and has an extending portion and two through holes disposed opposite each other. The rotational fixing element is rotatable to align the through holes with the top hole, and the installation fixing element passes through the top hole and the through holes. The light tube electrically connected to the two conductive plates and includes a tube body and two end caps provided at the two ends of the tube body. The end caps are respectively disposed on the two holders, and each of the end caps has an extending space engaged with the extending portion of the rotational fixing element corresponding thereto. The structural design of the installation fixing element ensures that the light tube of the lighting device can only be removed using tools, thereby significantly enhancing the safety and reliability of the lighting device.
(2) In one embodiment of the present invention, the rotational fixing element of the lighting device has an extending portion. Each of the end caps has an extending space engaged with the extending portion of the rotational fixing element. The mistake-proof structure formed by the extending spaces of the end caps and the extending portions of the rotational fixing elements effectively provides a mistake-proof function, such that the holder can be only installed with a matching light tube. Consequently, the lighting device will not be damage due to incorrect installation, which significantly enhances the service life of the lighting device.
(3) In one embodiment of the present invention, the end caps and holders of the lighting device have a special structural design, so the light tube can be stably fixed on the holder. Consequently, the lighting device achieves high structural stability, which can effectively prevent the light tube from falling off the holder. Therefore, the service life of the lighting device can be extended so as to further enhance the safety of the lighting device.
(4) In one embodiment of the present invention, the rotational fixing element of the holder of the lighting device has an extending portion with a special structural design, such that the extending space of the end cap can be stably engaged with the extending portion of the rotational fixing element. This structural design further enhances the structural stability of the lighting device.
(5) In one embodiment of the present invention, the two conductive pins of each end cap of the light tube are disposed on the two sides of the extending space of the end cap. Therefore, when the user rotates the light tube, the extending portion of the rotational fixing element embedded in the extending space provides appropriate assistance to alleviate the force applied to the two conductive pins. As a result, the conductive pins are less prone to deformation during the user's rotation of the light tube.
(6) In one embodiment of the present invention, the structural design of the mistake-proof structure in the lighting device is simple, so the lighting device can achieve desired technical effects without significantly increasing the cost thereof. Consequently, the practicality of the lighting device is significantly improved, so the lighting device can be more comprehensive in application and meet actual requirements.

Further scope of applicability of the present application will become more apparent from the detailed description given hereinafter. However, it should be understood that the detailed description and specific examples, while indicating exemplary embodiments of the present invention, are given by way of illustration only, since various changes and modifications within the spirit and scope of the present invention will become apparent to those skilled in the art from this detailed description.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is a perspective view of a lighting device having a mistake-proof structure in accordance with a first embodiment of the present invention.

FIG. 2 is a perspective view of an end cap of the lighting device having the mistake-proof structure in accordance with the first embodiment of the present invention.

FIG. 3 is an exploded view of a holder of the lighting device having the mistake-proof structure in accordance with the first embodiment of the present invention.

FIG. 4 is a perspective view of the holder of the lighting device having the mistake-proof structure in accordance with the first embodiment of the present invention.

FIG. 5 is a perspective view of a rotational fixing element of the lighting device having the mistake-proof structure in accordance with the first embodiment of the present invention.

FIG. 6 is an assembly view of the rotational fixing element and the holder of the lighting device having the mistake-proof structure in accordance with the first embodiment of the present invention.

FIG. 7 is a first schematic view of a usage state of the lighting device having the mistake-proof structure in accordance with the first embodiment of the present invention.

FIG. 8 is a second schematic view of the usage state of the lighting device having the mistake-proof structure in accordance with the first embodiment of the present invention.

FIG. 9 is a perspective view of a lighting device having a mistake-proof structure in accordance with a second embodiment of the present invention.

FIG. 10 is a perspective view of an end cap of the lighting device having the mistake-proof structure in accordance with the second embodiment of the present invention.

FIG. 11 is an exploded view of a holder of the lighting device having the mistake-proof structure in accordance with the second embodiment of the present invention.

FIG. 12 is a perspective view of the holder of the lighting device having the mistake-proof structure in accordance with the second embodiment of the present invention.

FIG. 13 is a perspective view of a rotational fixing element of the lighting device having the mistake-proof structure in accordance with the second embodiment of the present invention.

FIG. 14 is an assembly view of the rotational fixing element and the holder of the lighting device having the mistake-proof structure in accordance with the second embodiment of the present invention.

FIG. 15 is a first schematic view of a usage state of the lighting device having the mistake-proof structure in accordance with the second embodiment of the present invention.

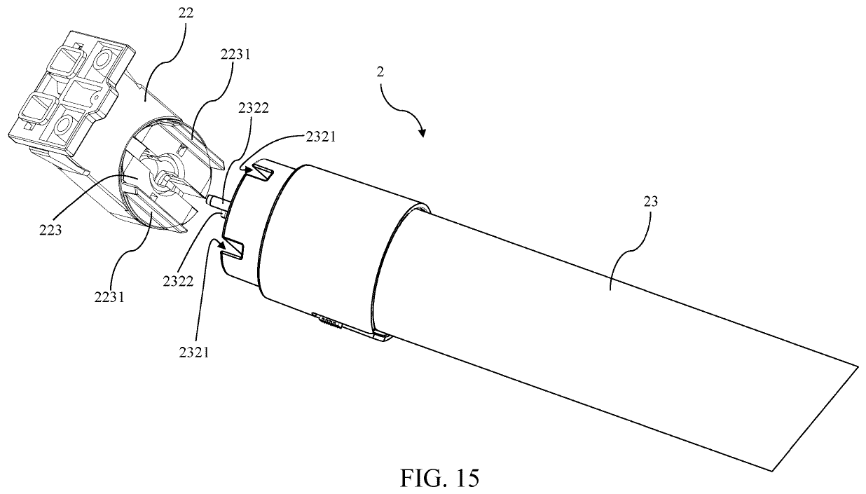

FIG. 16 is a second schematic view of the usage state of the lighting device having the mistake-proof structure in accordance with the second embodiment of the present invention.

FIG. 17 is a perspective view of an end cap of the lighting device having the mistake-proof structure in accordance with a third embodiment of the present invention.

FIG. 18 is a sideview of an end cap of the lighting device having the mistake-proof structure in accordance with the third embodiment of the present invention.

FIG. 19 is a perspective view of a holder of the lighting device having the mistake-proof structure in accordance with the third embodiment of the present invention.

FIG. 20 is a perspective view of a lighting device having a mistake-proof structure in accordance with a fourth embodiment of the present invention.

FIG. 21 is an exploded view of a holder of the lighting device having the mistake-proof structure in accordance with the fourth embodiment of the present invention.

FIG. 22 is a perspective view of the holder of the lighting device having the mistake-proof structure in accordance with the fourth embodiment of the present invention.

FIG. 23 is a first schematic view of a usage state of the holder of the lighting device having the mistake-proof structure in accordance with the fourth embodiment of the present invention.

FIG. 24 is a second schematic view of another usage state of the holder of the lighting device having the mistake-proof structure in accordance with the fourth embodiment of the present invention.

FIG. 25 is a first schematic view of the holder installed with an installation fixing element of the lighting device having the mistake-proof structure in accordance with the fourth embodiment of the present invention.

FIG. 26 is a second schematic view of the holder installed with another installation fixing element of the lighting device having the mistake-proof structure in accordance with the fourth embodiment of the present invention.

FIG. 27 is a third schematic view of the holder installed with still another installation fixing element of the lighting device having the mistake-proof structure in accordance with the fourth embodiment of the present invention.

FIG. 28 is a partial enlargement view of the lighting device having the mistake-proof structure in accordance with the fourth embodiment of the present invention.

FIG. 29 is a flowchart of a method for installing the lighting device having a mistake-proof structure in accordance with a fifth embodiment of the present invention.

FIG. 30 is a flowchart of a lighting device modifying method in accordance with a sixth embodiment of the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing. It should be understood that, when it is described that an element is “coupled” or “connected” to another element, the element may be “directly coupled” or “directly connected” to the other element or “coupled” or “connected” to the other element through a third element. In contrast, it should be understood that, when it is described that an element is “directly coupled” or “directly connected” to another element, there are no intervening elements.

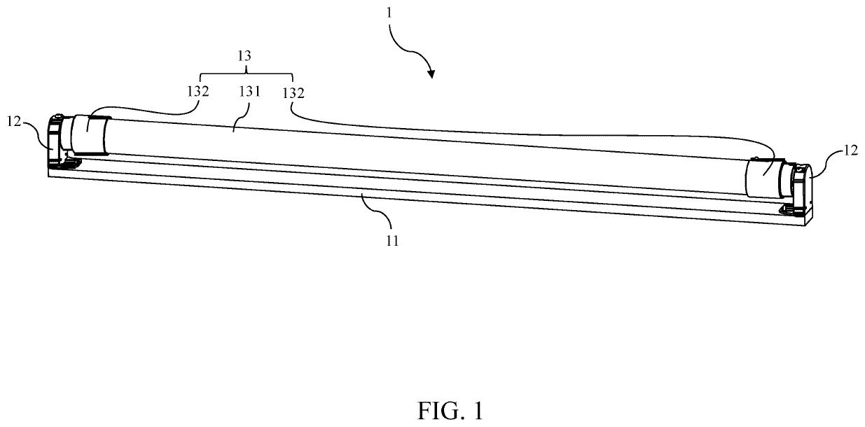

Please refer to FIG. 1, which is a perspective view of a lighting device having a mistake-proof structure in accordance with a first embodiment of the present invention. As shown in FIG. 1, the lighting device 1 includes an installation base 11, two holders 12, and a light tube 13. The light tube 13 is installed on the two holders 12, which are fixed on the installation base 11. The light tube 13 has a tube body 131 and two end caps 132 disposed at the two ends of the tube body 131. The two end caps 132 are respectively installed on the two holders 12.

The embodiment just exemplifies the present invention and is not intended to limit the scope of the present invention; any equivalent modification and variation according to the spirit of the present invention is to be also included within the scope of the following claims and their equivalents.

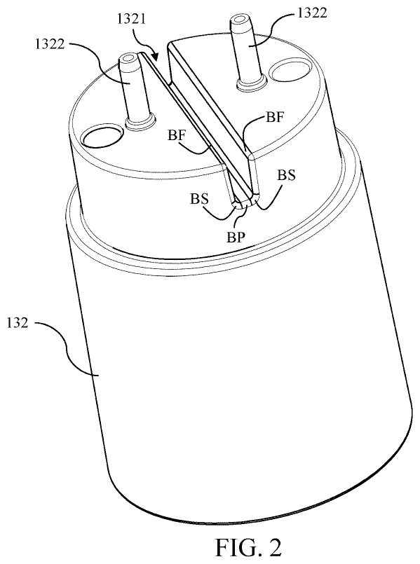

Please refer to FIG. 2, which is a perspective view of an end cap of the lighting device having the mistake-proof structure in accordance with the first embodiment of the present invention. As shown in FIG. 2, the end cap 132 has two conductive pins 1322 and an extending space 1321. The two conductive pins 1322 are disposed at the two sides of the extending space 1321. The conductive pins 1322 can be made of a metal material such as copper, iron, aluminum, or other conductive alloy materials. In this embodiment, the extending space 1321 is a groove. The bottom surface of the extending space 1321 has a bottom plane BP and two inclined bottom surfaces BS. The bottom plane BP is disposed between the two inclined bottom surfaces BS. The top end of the extending space 1321 has two buffer surfaces BF. In another embodiment, the extending space 1321 can also be a hole, such as a circular hole, a rectangular hole, or holes of various shapes. In yet another embodiment, the extending space 1321 can be a concave surface, a concave point, a concave stair structure, an inclined plane, or various structures with similar functions. The above structure of the extending space 1321 is just for illustration, which may vary according to actual requirements; the present invention is not limited thereto.

The embodiment just exemplifies the present invention and is not intended to limit the scope of the present invention; any equivalent modification and variation according to the spirit of the present invention is to be also included within the scope of the following claims and their equivalents.

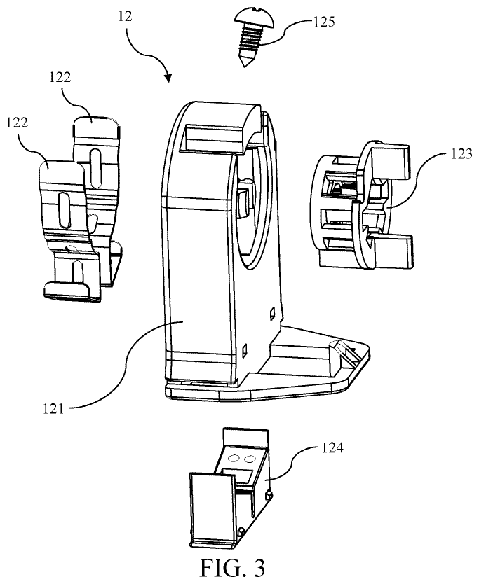

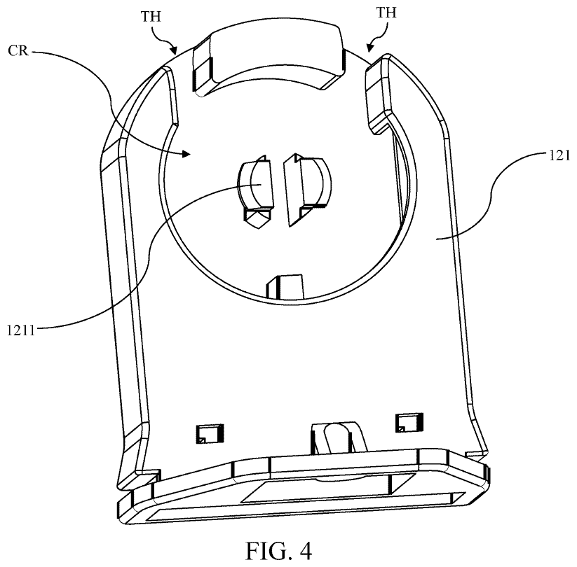

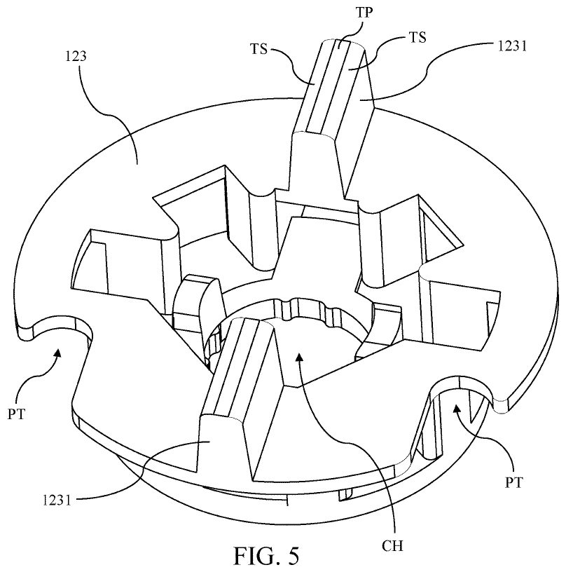

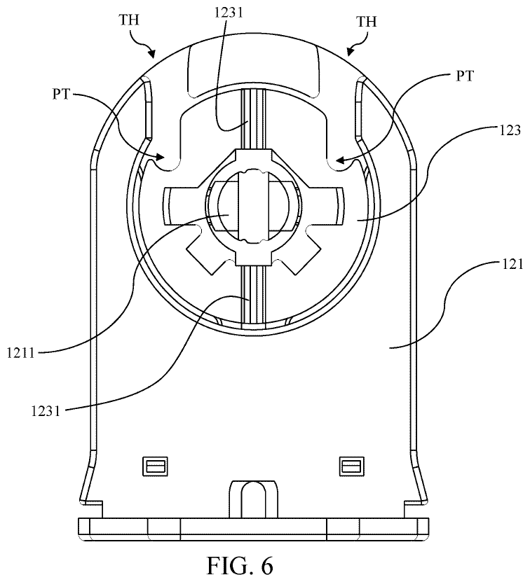

Please refer to FIG. 3, FIG. 4, FIG. 5 and FIG. 6. FIG. 3 is an exploded view of a holder of the lighting device having the mistake-proof structure in accordance with the first embodiment of the present invention. FIG. 4 is a perspective view of the holder of the lighting device having the mistake-proof structure in accordance with the first embodiment of the present invention. FIG. 5 is a perspective view of a rotational fixing element of the lighting device having the mistake-proof structure in accordance with the first embodiment of the present invention. FIG. 6 is an assembly view of the rotational fixing element and the holder of the lighting device having the mistake-proof structure in accordance with the first embodiment of the present invention. As shown in FIG. 3, FIG. 4, FIG. 5 and FIG. 6, the holder 12 includes a holder body 121, two conductive plates 122, a rotational fixing element 123, a fixing base 124, and a fixing element 125.

The central recess CR of the holder body 121 is provided with a central post 1211, and the top of the holder body 121 is provided with two top holes TH.

The two conductive plates 122 and the fixing base 124 are disposed in the holder body 121, with the conductive plates 122 fixed to the fixing base 124. The two conductive plates 122 may be made of a metal material, such as copper, iron, aluminum or other conductive alloy materials.

The rotational fixing element 123 is disposed in the central recess CR of the holder body 121 and has two extending portions 1231, a central hole CH, and two positioning grooves PT. The central post 1211 of the holder body 121 passes through the central hole CH of the rotational fixing element 123, such that the rotational fixing element 123 can be rotatably connected to the central post 1211. The two positioning grooves PT are corresponding to the two top holes TH and are disposed at the two sides of one of the extending portions 1231. Therefore, the holder 22 may be based on a two-channel design. In the embodiment, the extending portions 1231 may be a positioning plate and disposed on the upper surface of the rotational fixing element 123, and the width of the extending portion 1231 gradually decreases toward the direction away from the upper surface of the rotational fixing element 123. The surface at the top of the extending portion 1231 has a top plane TP and two inclined top surfaces TS, and the top plane TP is disposed between the two inclined top surfaces TS. In another embodiment, the extending portion 1231 may be a positioning block, which can be a cylindrical body, a polygonal body, or other shapes. In yet another embodiment, the extending portion 1231 can also be a protruded stage, a protruded point, a protruded stair structure, an inclined plane, a snap-fit structure, or various structures with similar functions. The total length of the two extending portions 1231 may be greater than half the length of the extending space 1321, and the two extending portions 1231 are designed to be mutually symmetrical. The above structure of the extending portion 1231 is just for illustration, which can vary according to actual requirements; the present invention is not limited thereto.

The embodiment just exemplifies the present invention and is not intended to limit the scope of the present invention; any equivalent modification and variation according to the spirit of the present invention is to be also included within the scope of the following claims and their equivalents.

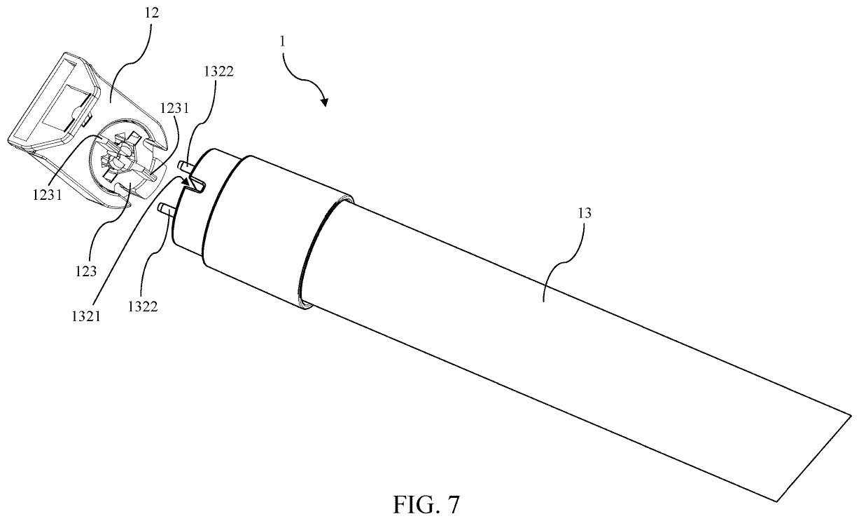

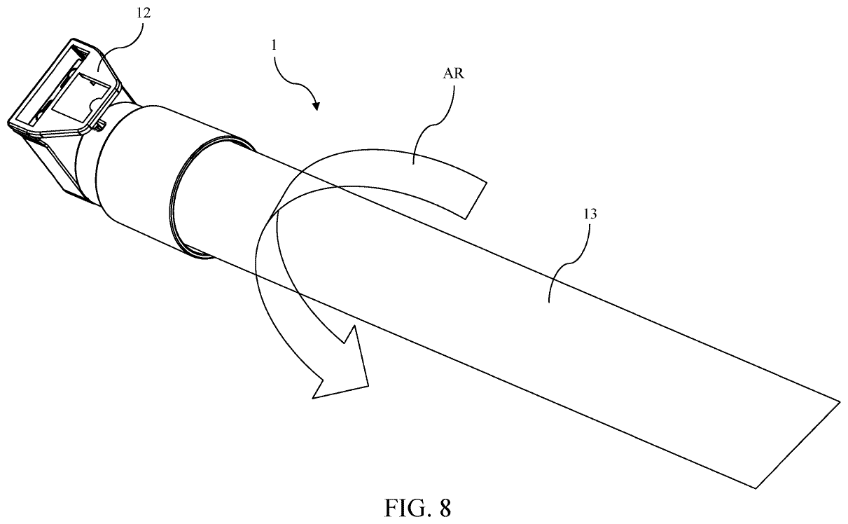

Please refer to FIG. 7 and FIG. 8, which are a first schematic view and a second schematic view of a usage state of the lighting device having the mistake-proof structure in accordance with the first embodiment of the present invention respectively. Please also refer to FIG. 1˜FIG. 6. As shown in FIG. 7 and FIG. 8, when a user intends to install the light tube 13 onto the holder 12, the user aligns the two conductive pins 1322 of each end cap 132 with the two top holes TH of the corresponding holder body 121, such that the conductive pins 1322 can pass through the top holes TH and be inserted into the positioning grooves PT of the rotational fixing element 123 of the holder 12. Simultaneously, the two extending portions 1231 of the rotational fixing element 123 are engaged with the extending spaces 1321 of the end caps 132. Subsequently, the user can rotate the light tube 13 by a predetermined angle (in the direction indicated by arrow AR, which can be clockwise or counterclockwise) so that the two conductive pins 1322 of each end cap 132 contact the two conductive plates 122 inside the holder body 121, establishing electrical connection between the light tube 13 and the conductive plates 122 of the holder 12. Finally, the user can fix the fixing element 125 at one of the top holes TH of the holder body 121 to prevent the light tube 13 from falling.

According to the embodiment, involving the extending spaces 1321 of the end caps 132 and the extending portions 1231 of the rotational fixing element 123, constitutes a mistake-proof structure that effectively provides a mistake-proof function. In this way, that the light tube 13 can be installed on a matching holder 12. Consequently, the lighting device 1 is safeguarded against damage due to incorrect installation, so the service life of the lighting device 1 can be significantly increased. Additionally, the special structural design of the end caps 132 and the holder 12 ensures a secure fixation of the light tube 13 onto the holder 12, achieving high structural stability and effectively preventing the light tube 13 from falling. Moreover, the rotational fixing element 123 of the holder 12 features extending portions 1231 with a special structural design, allowing them to securely be engaged with the extending spaces 1321 of the end caps 132. As mentioned earlier, the two conductive pins 1322 of each end cap 132 are disposed on the two sides of the extending space 1321 respectively. Furthermore, the total length of the two extending portions 1231 may be greater than half the length of the extending space 1321, and the two extending portions 1231 are symmetrically designed. Consequently, when the user rotates the light tube 13, the extending portions 1231 of the rotational fixing element 123 embedded in the extending space 1321 can provide appropriate assistance to alleviate the force exerted on the two conductive pins 1322. Therefore, the conductive pins 1322 are less prone to deformation when the user rotates the light tube 13.

This structural design can effectively prevent the user from installing a conventional light tube onto the holder of an emergency lighting device. This structural design can also effectively prevent the user from installing the light tube of an emergency lighting device onto the holder of a conventional lighting device. Therefore, the structure enhances the safety of the lighting device, preventing damage to the device.

The embodiment just exemplifies the present invention and is not intended to limit the scope of the present invention; any equivalent modification and variation according to the spirit of the present invention is to be also included within the scope of the following claims and their equivalents.

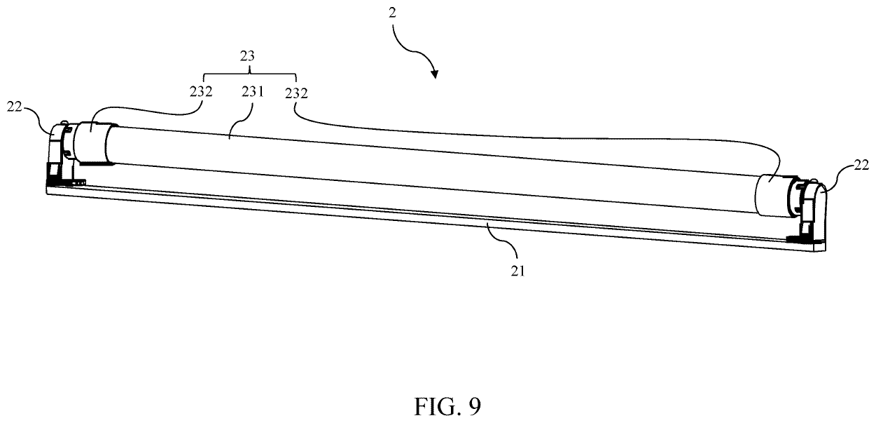

Please refer to FIG. 9, which is a perspective view of a lighting device having a mistake-proof structure in accordance with a second embodiment of the present invention. As shown in FIG. 9, the lighting device 2 includes an installation base 21, two holders 22, and a light tube 23. The light tube 23 is installed on the two holders 22, which are fixed on the installation base 21. The light tube 23 has a tube body 231 and two end caps 232 disposed at the two ends of the tube body 231. The two end caps 232 are respectively installed on the two holders 22.

The embodiment just exemplifies the present invention and is not intended to limit the scope of the present invention; any equivalent modification and variation according to the spirit of the present invention is to be also included within the scope of the following claims and their equivalents.

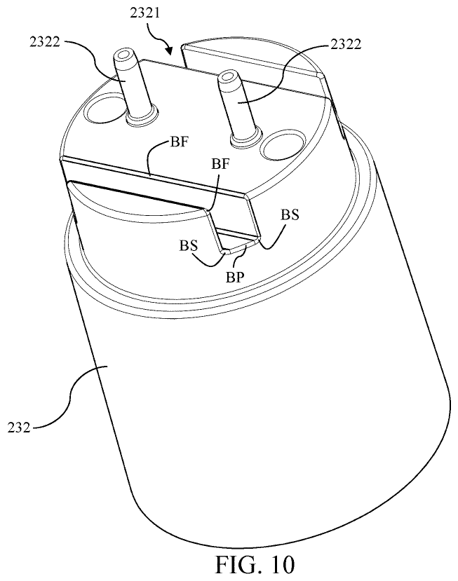

Please refer to FIG. 10, which is a perspective view of an end cap of the lighting device having the mistake-proof structure in accordance with the second embodiment of the present invention. As shown in FIG. 10, the end cap 232 has two conductive pins 2322 and two extending spaces 2321. The two conductive pins 2322 are disposed between the two extending spaces 2321. One of the two conductive pins 2322 is disposed at one side of one of the extending spaces 2321, and the other one of the two conductive pins 2322 is disposed at one side of the other one of the extending spaces 2321. The conductive pins 2322 can be made of a metal material such as copper, iron, aluminum, or other conductive alloy materials. In this embodiment, the extending space 2321 is a groove. The bottom surface of the extending space 2321 has a bottom plane BP and two inclined bottom surfaces BS. The bottom plane BP is disposed between the two inclined bottom surfaces BS. The top end of the extending space 1321 has two buffer surfaces BF. In another embodiment, the extending space 1321 can also be a hole, such as a circular hole, a rectangular hole, or holes of various shapes. In yet another embodiment, the extending space 1321 can be a concave surface, a concave point, a concave stair structure, an inclined plane, or various structures with similar functions. The above structure of the extending space 1321 is just for illustration, which may vary according to actual requirements; the present invention is not limited thereto.

The embodiment just exemplifies the present invention and is not intended to limit the scope of the present invention; any equivalent modification and variation according to the spirit of the present invention is to be also included within the scope of the following claims and their equivalents.

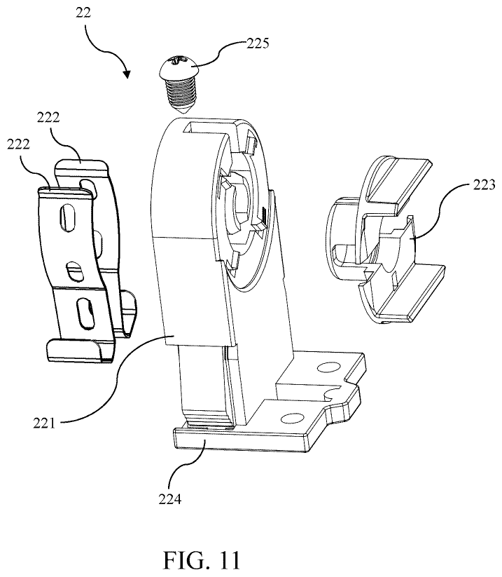

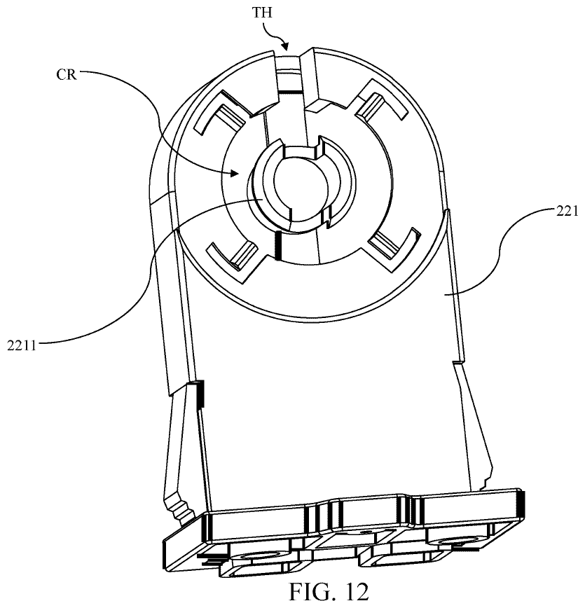

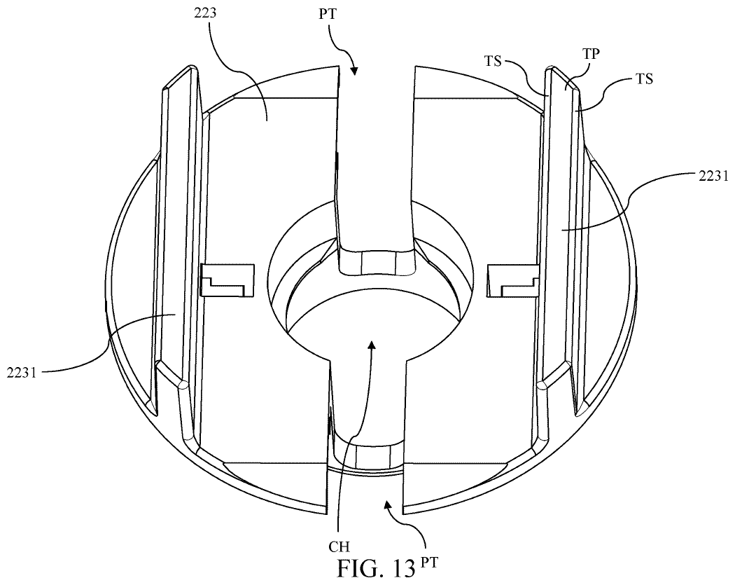

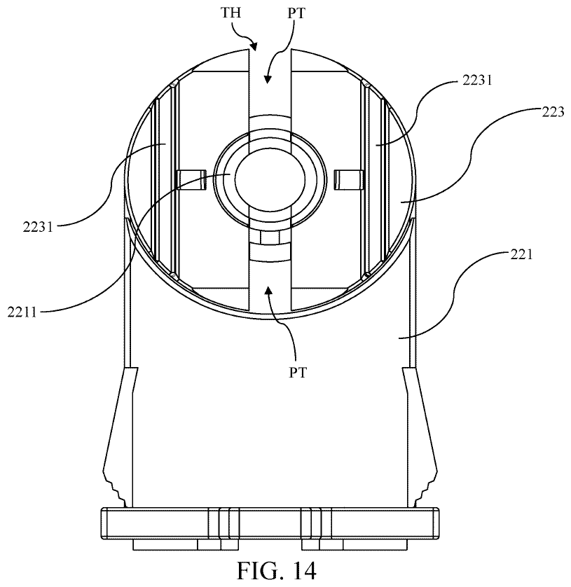

Please refer to FIG. 11, FIG. 12, FIG. 13 and FIG. 14. FIG. 11 is an exploded view of a holder of the lighting device having the mistake-proof structure in accordance with the second embodiment of the present invention. FIG. 12 is a perspective view of the holder of the lighting device having the mistake-proof structure in accordance with the second embodiment of the present invention. FIG. 13 is a perspective view of a rotational fixing element of the lighting device having the mistake-proof structure in accordance with the second embodiment of the present invention. FIG. 14 is an assembly view of the rotational fixing element and the holder of the lighting device having the mistake-proof structure in accordance with the second embodiment of the present invention. As shown in FIG. 11, FIG. 12, FIG. 13 and FIG. 14, the holder 22 includes a holder body 221, two conductive plates 222, a rotational fixing element 223, a fixing base 224, and a fixing element 225.

The central recess CR of the holder body 221 is provided with a central post 2211, and the top of the holder body 2121 is provided with a top hole TH.

The two conductive plates 222 and the fixing base 224 are disposed in the holder body 221, with the conductive plates 222 fixed to the fixing base 224. The two conductive plates 222 may be made of a metal material, such as copper, iron, aluminum or other conductive alloy materials.

The rotational fixing element 223 is disposed in the central recess CR of the holder body 221 and has two extending portions 2231, a central hole CH, and two positioning grooves PT. The central post 2211 of the holder body 221 passes through the central hole CH of the rotational fixing element 223, such that the rotational fixing element 223 can be rotatably connected to the central post 2211. The two positioning grooves PT is corresponding to the top hole TH and are disposed to be opposite to each other; the central hole CH serves as the central point of the two positioning grooves PT. In this way, the central hole TH and the central hole CH can form a channel. Therefore, the holder 22 may be based on a one-channel design. In the embodiment, the extending portions 2231 may be a positioning plate and disposed on the upper surface of the rotational fixing element 223, and the width of the extending portion 2231 gradually decreases toward the direction away from the upper surface of the rotational fixing element 223. The surface at the top of the extending portion 2231 has a top plane TP and two inclined top surfaces TS, and the top plane TP is disposed between the two inclined top surfaces TS. In another embodiment, the extending portion 2231 may be a positioning block, which can be a cylindrical body, a polygonal body, or other shapes. In yet another embodiment, the extending portion 2231 can also be a protruded stage, a protruded point, a protruded stair structure, an inclined plane, a snap-fit structure, or various structures with similar functions. The total length of the two extending portions 2231 may be greater than half the length of the extending space 2321, and the two extending portions 2231 are designed to be mutually symmetrical. The above structure of the extending portion 2231 is just for illustration, which can vary according to actual requirements; the present invention is not limited thereto.

The embodiment just exemplifies the present invention and is not intended to limit the scope of the present invention; any equivalent modification and variation according to the spirit of the present invention is to be also included within the scope of the following claims and their equivalents.

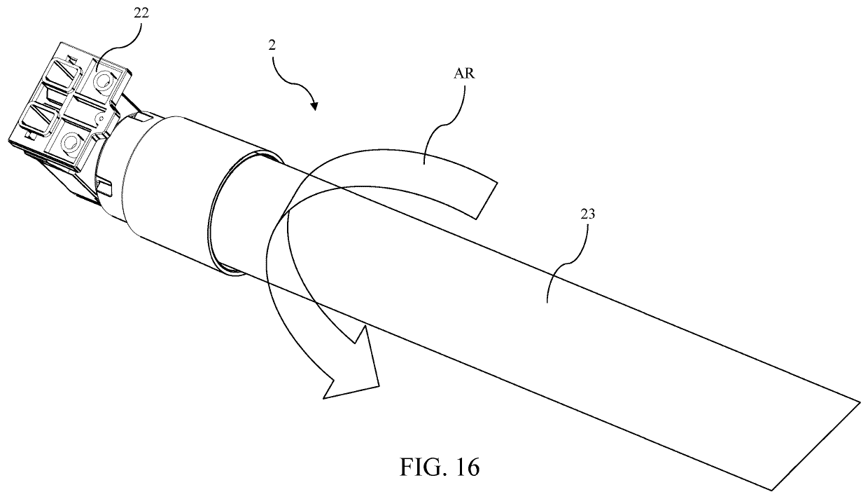

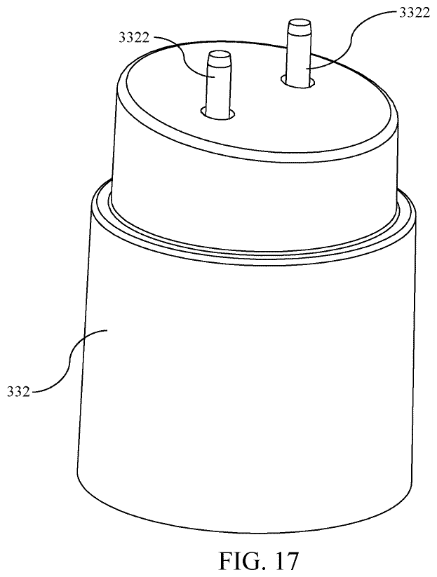

Please refer to FIG. 16 and FIG. 17, which are a first schematic view and a second schematic view of a usage state of the lighting device having the mistake-proof structure in accordance with the second embodiment of the present invention respectively. Please also refer to FIG. 9˜ FIG. 14. As shown in FIG. 16 and FIG. 17, when a user intends to install the light tube 23 onto the holder 22, the user aligns the two conductive pins 2322 of each end cap 232 with the top hole TH of the corresponding holder body 221, such that the conductive pins 2322 can pass through the top hole TH and be inserted into the positioning grooves PT of the rotational fixing element 223 of the holder 22. Simultaneously, the two extending portions 2231 of the rotational fixing element 223 are engaged with the extending spaces 2321 of the end caps 232. Subsequently, the user can rotate the light tube 23 by a predetermined angle (in the direction indicated by arrow AR, which can be clockwise or counterclockwise) so that the two conductive pins 2322 of each end cap 232 contact the two conductive plates 222 inside the holder body 221 in order to establish electrical connection between the light tube 23 and the conductive plates 222 of the holder 22. Finally, the user can fix the fixing element 225 at the top hole TH of the holder body 221 to prevent the light tube 23 from falling.

The embodiment just exemplifies the present invention and is not intended to limit the scope of the present invention; any equivalent modification and variation according to the spirit of the present invention is to be also included within the scope of the following claims and their equivalents.

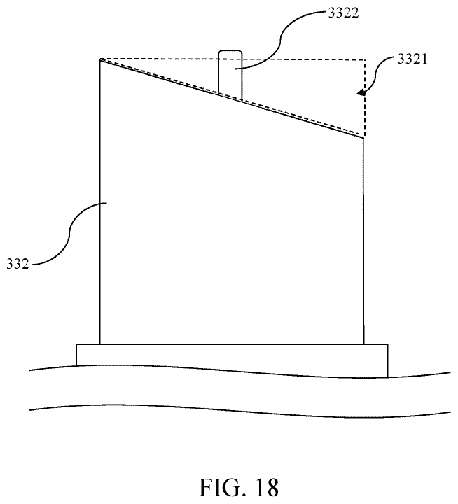

Please refer to FIG. 17 and FIG. 18, which are a perspective view and a side view of an end cap of the lighting device having the mistake-proof structure in accordance with a third embodiment of the present invention respectively. Please also refer to FIG. 1. As shown in FIG. 17 and FIG. 18, the end cap 332 has two conductive pins 3322 and an extending space 3321. The above two conductive pins 3322 are disposed at the two sides of the extending space 3321. In the embodiment, the extending space 3321 is a recess formed by a slope. The above structural design makes the end cap 332 have an inclined surface.

The embodiment just exemplifies the present invention and is not intended to limit the scope of the present invention; any equivalent modification and variation according to the spirit of the present invention is to be also included within the scope of the following claims and their equivalents.

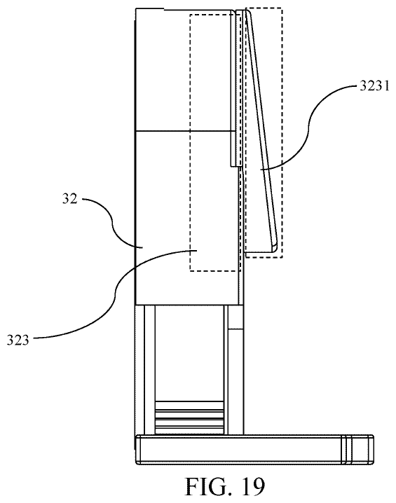

As shown in FIG. 19, which is a perspective view of a holder of the lighting device having the mistake-proof structure in accordance with the third embodiment of the present invention. As shown in FIG. 19, the structure of the holder 32 is similar to the holder of the previous embodiment. The difference between this embodiment and the previous embodiment is that the extending portion of the rotational fixing element 323 of the holder 32 is a positioning slope.

Similarly, the extending portion 3231 of the rotational fixing element 323 can match the extending space 3321 of the end cap 332 so as to provide the mistake-proof function.

The embodiment just exemplifies the present invention and is not intended to limit the scope of the present invention; any equivalent modification and variation according to the spirit of the present invention is to be also included within the scope of the following claims and their equivalents.

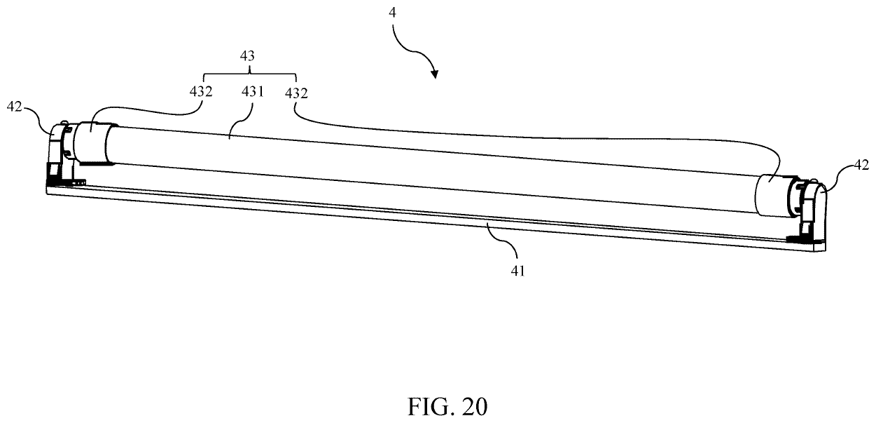

Please refer to FIG. 20, which is a perspective view of a lighting device having a mistake-proof structure in accordance with a fourth embodiment of the present invention. As shown in FIG. 20, the lighting device 4 includes an installation base 41, two holders 42, and a light tube 43. The light tube 43 is installed on the two holders 42, which are fixed to the installation base 41. The light tube 43 has a tube body 431 and two end caps 432 disposed at the ends of the tube body 431. The two end caps 432 are respectively installed on the two holders 42. Each end cap 432 further includes an extending space.

The embodiment just exemplifies the present invention and is not intended to limit the scope of the present invention; any equivalent modification and variation according to the spirit of the present invention is to be also included within the scope of the following claims and their equivalents.

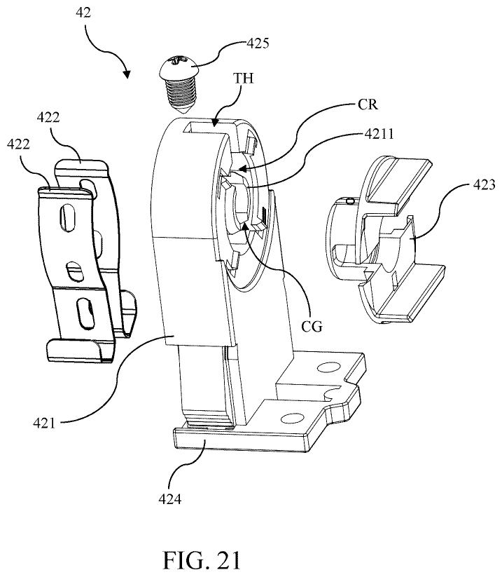

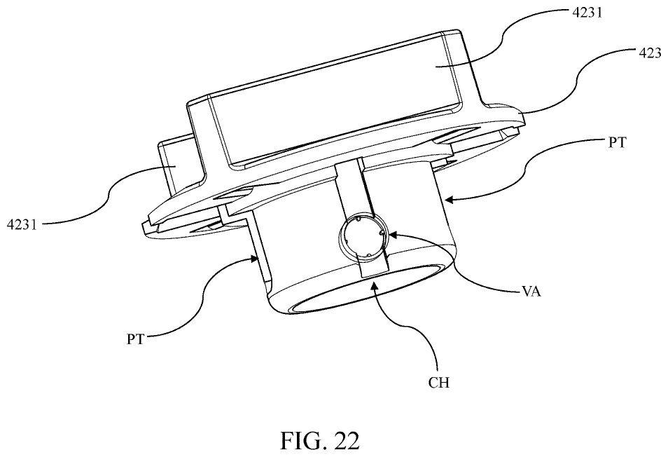

Please refer to FIG. 21 and FIG. 22. FIG. 21 is an exploded view of a holder of the lighting device having the mistake-proof structure in accordance with the fourth embodiment of the present invention. FIG. 22 is a perspective view of the holder of the lighting device having the mistake-proof structure in accordance with the fourth embodiment of the present invention. As shown in FIG. 21, each holder 42 includes a holder body 421, two conductive plates 422, a rotational fixing element 423, a fixed base 424, and a fixing element 425. The two conductive plates 422 and the fixed base 424 are disposed in the holder body 421, and the conductive plates 422 are fixed to the fixed base 424. The holder body 421 has a top hole TH, a central post 4211, and a central recess CR. The central post 4211 is disposed in the central recess CR and includes a central groove CG. The rotational fixing element 423 is rotatably connected to the central post 4211.

As shown in FIG. 22, the rotational fixing element 423 includes a central hole CH. The central post 4211 passes through the central hole CH, enabling the rotational fixing element 423 to be rotatably connected to the central post CH. The rotational fixing element 423 also has two opposing through holes VA. The rotational fixing element 423 can rotate to align the two through holes VA with the top hole TH. Due to the central groove CG in the central post 4211, the two through holes VA align with both the central groove CG and the top hole TH.

Similarly, the rotational fixing element 423 may include an extending portion 4231 and two positioning grooves PT. The extending portion 4231 may be a positioning plate. The structure of the extending portion 4231 and the two positioning grooves PT is similar to that of the second embodiment and is not described in detail here. In another embodiment, the extending portion 4231 may also be a positioning block or a positioning slope. The extending portion 4231 of the rotational fixing element 423 can be engaged with the extending space of the end cap 432. The extending space may be a groove. In another embodiment, the extending space may also be a hole or a recess formed by a slope. This structure is disclosed in the second embodiment and will not be elaborated here. Similarly, each end cap 432 also includes two conductive pins, which are inserted into the corresponding rotational fixing element 423, so that the conductive pins respectively contact the two conductive plates 422 and are positioned on the two sides of the extending space. The structure of the conductive pins is identical to that of the second embodiment and is not reiterated or illustrated here.

The embodiment just exemplifies the present invention and is not intended to limit the scope of the present invention; any equivalent modification and variation according to the spirit of the present invention is to be also included within the scope of the following claims and their equivalents.

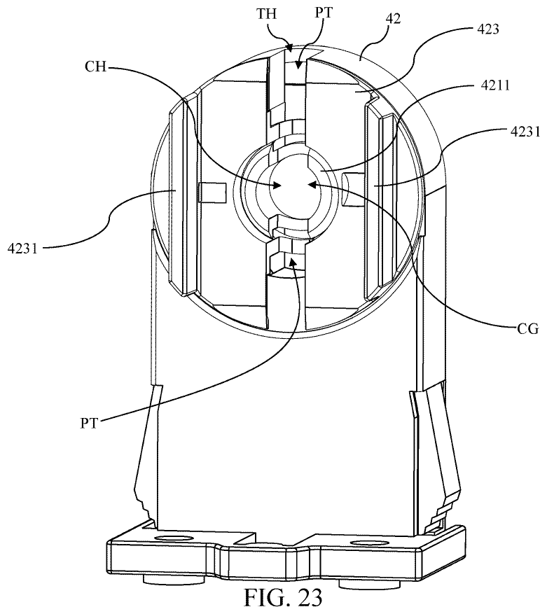

Please refer to FIG. 23, which is a first schematic view of a usage state of the holder of the lighting device having the mistake-proof structure in accordance with the fourth embodiment of the present invention. As shown in FIG. 23, the rotational fixing element 423 can rotate to align the positioning grooves PT with the top hole TH. At this point, the top hole TH, the two positioning grooves PT, the central hole CH, and the central groove CG form a channel. This configuration allows the user to install the light tube 23.

The embodiment just exemplifies the present invention and is not intended to limit the scope of the present invention; any equivalent modification and variation according to the spirit of the present invention is to be also included within the scope of the following claims and their equivalents.

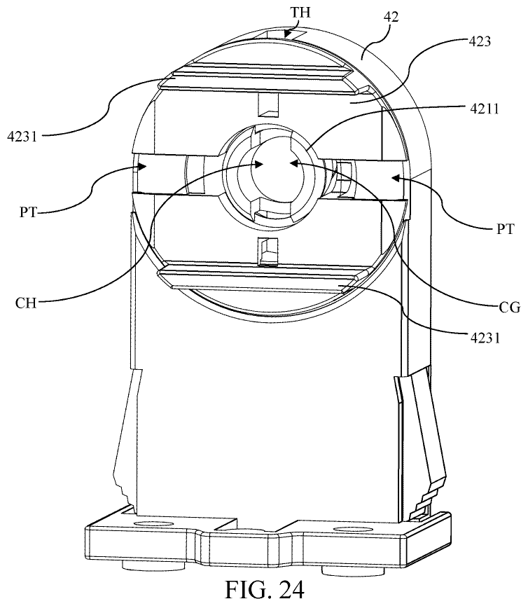

Please refer to FIG. 24, which is a second schematic view of another usage state of the holder of the lighting device having the mistake-proof structure in accordance with the fourth embodiment of the present invention. As shown in FIG. 24, the rotational fixing element 423 can rotate to align the through holes VA with the central groove CG and the top hole TH. At this point, the top hole TH, the through holes VA, the central hole CH, and the central groove CG form a channel.

The embodiment just exemplifies the present invention and is not intended to limit the scope of the present invention; any equivalent modification and variation according to the spirit of the present invention is to be also included within the scope of the following claims and their equivalents.

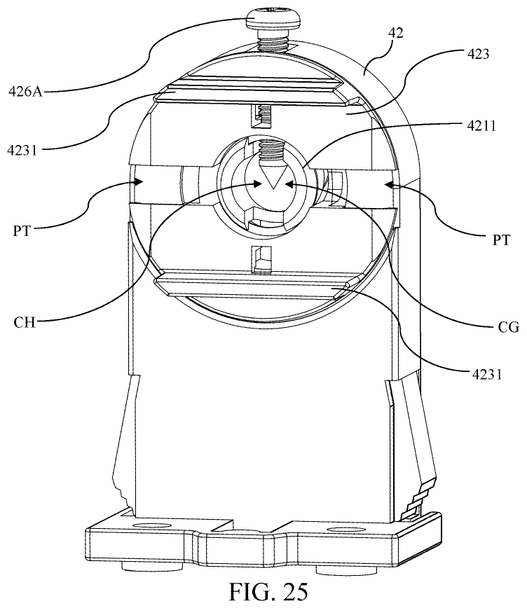

Please refer to FIG. 25, which is a first schematic view of the holder installed with an installation fixing element of the lighting device having the mistake-proof structure in accordance with the fourth embodiment of the present invention. As shown in FIG. 25, each holder 42 further includes an installation fixing element 426A. The installation fixing element 426A passes through the top hole TH, the two through holes VA, and the central groove CG. In this embodiment, the installation fixing element 426A is a screw.

The embodiment just exemplifies the present invention and is not intended to limit the scope of the present invention; any equivalent modification and variation according to the spirit of the present invention is to be also included within the scope of the following claims and their equivalents.

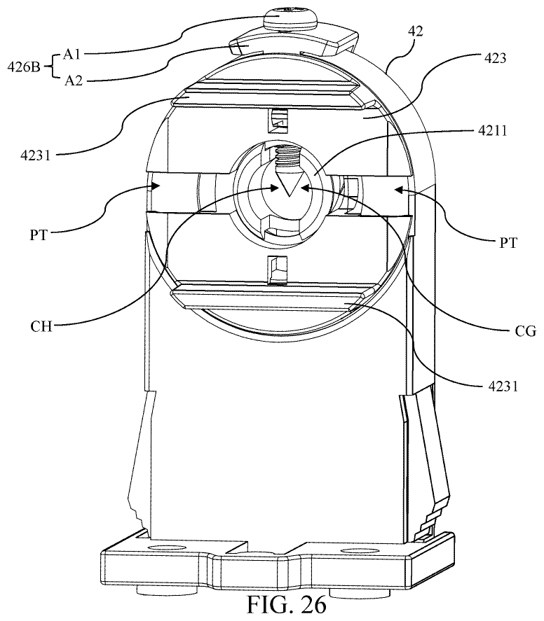

Please refer to FIG. 26, which is a second schematic view of the holder installed with another installation fixing element of the lighting device having the mistake-proof structure in accordance with the fourth embodiment of the present invention. As shown in FIG. 26, each holder 42 further includes an installation fixing element 426B. The installation fixing element 426B passes through the top hole TH, the two through holes VA, and the central groove CG. In this embodiment, the installation fixing element 426B is the combination of a screw A1 and a snap fastener A2.

The embodiment just exemplifies the present invention and is not intended to limit the scope of the present invention; any equivalent modification and variation according to the spirit of the present invention is to be also included within the scope of the following claims and their equivalents.

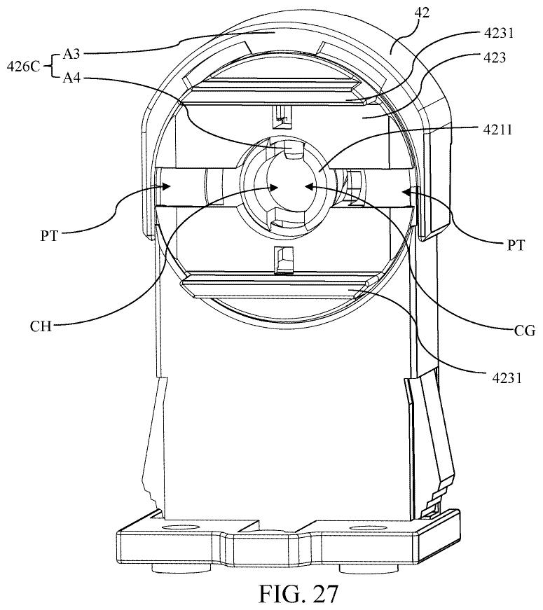

Please refer to FIG. 27, which is a third schematic view of the holder installed with still another installation fixing element of the lighting device having the mistake-proof structure in accordance with the fourth embodiment of the present invention. As shown in FIG. 27, each holder 42 further includes an installation fixing element 426C. The installation fixing element 426C passes through the top hole TH, the through holes VA, and the central groove CG. In this embodiment, the installation fixing element 426C includes a fixing cap A3 and a fixing post A4 connected to each other. The fixed post A4 passes through the top hole TH, the through holes VA, and the central groove CG, while the fixed cap A3 covers the top of the holder 42.

The embodiment just exemplifies the present invention and is not intended to limit the scope of the present invention; any equivalent modification and variation according to the spirit of the present invention is to be also included within the scope of the following claims and their equivalents.

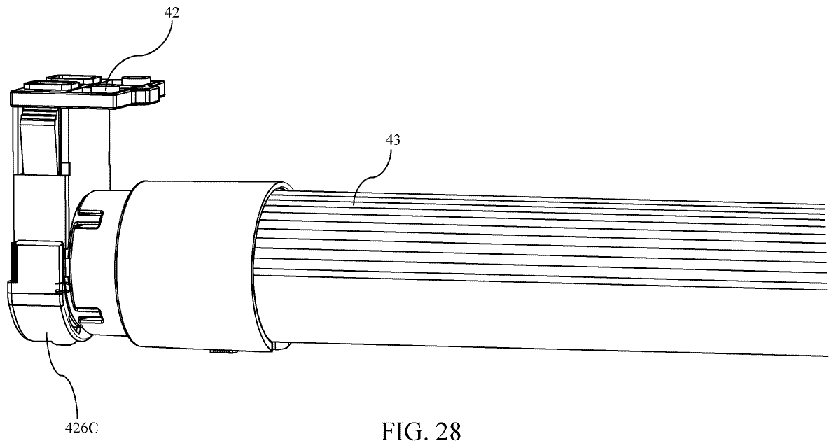

Please refer to FIG. 28, which is a partial enlargement view of the lighting device having the mistake-proof structure in accordance with the fourth embodiment of the present invention. As shown in FIG. 28, the structural design of the installation fixing element 426C ensures that the light tube 43 of the lighting device 4 can only be removed using tools, significantly enhancing the safety and reliability of the lighting device 4. Additionally, the installation fixing element 426C improves the overall appearance of the lighting device 4.

The embodiment just exemplifies the present invention and is not intended to limit the scope of the present invention; any equivalent modification and variation according to the spirit of the present invention is to be also included within the scope of the following claims and their equivalents.

It is worthy to point out that currently available light tubes have no a proper mistake-proof structure, so users tend to incorrectly install these light tubes on the holders not matching these light tubes. By contrast, according to one embodiment of the present invention, the lighting device includes two holders and a light tube. Each holder includes a holder body, two conductive plates, a rotational fixing element, and an installation fixing element. The conductive plates are disposed in the holder body, and the holder body has a top hole, a central post, and a central recess. The central post is disposed in the central recess, and the rotational fixing element is rotatably connected to the central post, and has an extending portion and two through holes disposed opposite each other. The rotational fixing element is rotatable to align the through holes with the top hole, and the installation fixing element passes through the top hole and the through holes. The light tube electrically connected to the two conductive plates and includes a tube body and two end caps provided at the two ends of the tube body. The end caps are respectively disposed on the two holders, and each of the end caps has an extending space engaged with the extending portion of the rotational fixing element corresponding thereto. The structural design of the installation fixing element ensures that the light tube of the lighting device can only be removed using tools, thereby significantly enhancing the safety and reliability of the lighting device.

According to one embodiment of the present invention, the rotational fixing element of the lighting device has an extending portion. Each of the end caps has an extending space engaged with the extending portion of the rotational fixing element. The mistake-proof structure formed by the extending spaces of the end caps and the extending portions of the rotational fixing elements effectively provides a mistake-proof function, such that the holder can be only installed with a matching light tube. Consequently, the lighting device will not be damage due to incorrect installation, which significantly enhances the service life of the lighting device.

Also, according to one embodiment of the present invention, the end caps and holders of the lighting device have a special structural design, so the light tube can be stably fixed on the holder. Consequently, the lighting device achieves high structural stability, which can effectively prevent the light tube from falling off the holder. Therefore, the service life of the lighting device can be extended so as to further enhance the safety of the lighting device.

Further, according to one embodiment of the present invention, the rotational fixing element of the holder of the lighting device has an extending portion with a special structural design, such that the extending space of the end cap can be stably engaged with the extending portion of the rotational fixing element. This structural design further enhances the structural stability of the lighting device.

Moreover, according to one embodiment of the present invention, the two conductive pins of each end cap of the light tube are disposed on the two sides of the extending space of the end cap. Therefore, when the user rotates the light tube, the extending portion of the rotational fixing element embedded in the extending space provides appropriate assistance to alleviate the force applied to the two conductive pins. As a result, the conductive pins are less prone to deformation during the user's rotation of the light tube.

Furthermore, according to one embodiment of the present invention, the structural design of the mistake-proof structure in the lighting device is simple, so the lighting device can achieve desired technical effects without significantly increasing the cost thereof. Consequently, the practicality of the lighting device is significantly improved, so the lighting device can be more comprehensive in application and meet actual requirements. As set forth above, the lighting device having the mistake-proof structure according to the embodiments of the present invention can definitely achieve great technical effects.

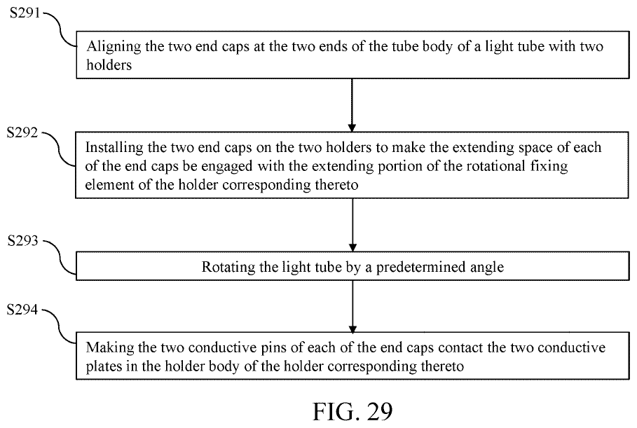

FIG. 29 is a flowchart of a method for installing the lighting device having a mistake-proof structure in accordance with a fifth embodiment of the present invention. As shown in FIG. 29, the method of the embodiment includes the following steps:

Step S291: aligning the two end caps at the two ends of the tube body of a light tube with two holders.

Step S292: installing the two end caps on the two holders to make the extending space of each of the end caps be engaged with the extending portion of the rotational fixing element of the holder corresponding thereto.

Step S293: rotating the light tube by a predetermined angle.

Step S294: making the two conductive pins of each of the end caps contact the two conductive plates in the holder body of the holder corresponding thereto.

The embodiment just exemplifies the present invention and is not intended to limit the scope of the present invention; any equivalent modification and variation according to the spirit of the present invention is to be also included within the scope of the following claims and their equivalents.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

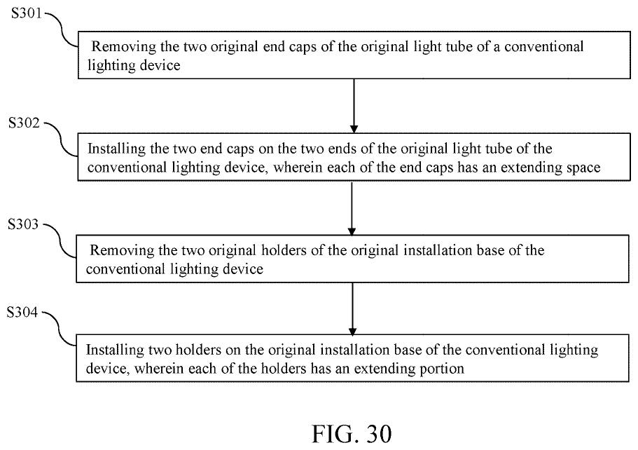

Please refer to FIG. 30, which is a flowchart of a lighting device modifying method in accordance with a sixth embodiment of the present invention. As shown in FIG. 30, the method of the embodiment includes the following steps:

Step S301: removing the two original end caps of the original light tube of a conventional lighting device.

Step S302: installing the two end caps on the two ends of the original light tube of the conventional lighting device, wherein each of the end caps has an extending space.

Step S303: removing the two original holders of the original installation base of the conventional lighting device.

Step S304: installing two holders on the original installation base of the conventional lighting device, wherein each of the holders has an extending portion.

The embodiment just exemplifies the present invention and is not intended to limit the scope of the present invention; any equivalent modification and variation according to the spirit of the present invention is to be also included within the scope of the following claims and their equivalents.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

To sum up, according to one embodiment of the present invention, the lighting device includes two holders and a light tube. Each holder includes a holder body, two conductive plates, a rotational fixing element, and an installation fixing element. The conductive plates are disposed in the holder body, and the holder body has a top hole, a central post, and a central recess. The central post is disposed in the central recess, and the rotational fixing element is rotatably connected to the central post, and has an extending portion and two through holes disposed opposite each other. The rotational fixing element is rotatable to align the through holes with the top hole, and the installation fixing element passes through the top hole and the through holes. The light tube electrically connected to the two conductive plates and includes a tube body and two end caps provided at the two ends of the tube body. The end caps are respectively disposed on the two holders, and each of the end caps has an extending space engaged with the extending portion of the rotational fixing element corresponding thereto. The structural design of the installation fixing element ensures that the light tube of the lighting device can only be removed using tools, thereby significantly enhancing the safety and reliability of the lighting device.

According to one embodiment of the present invention, the rotational fixing element of the lighting device has an extending portion. Each of the end caps has an extending space engaged with the extending portion of the rotational fixing element. The mistake-proof structure formed by the extending spaces of the end caps and the extending portions of the rotational fixing elements effectively provides a mistake-proof function, such that the holder can be only installed with a matching light tube. Consequently, the lighting device will not be damage due to incorrect installation, which significantly enhances the service life of the lighting device.

Also, according to one embodiment of the present invention, the end caps and holders of the lighting device have a special structural design, so the light tube can be stably fixed on the holder. Consequently, the lighting device achieves high structural stability, which can effectively prevent the light tube from falling off the holder. Therefore, the service life of the lighting device can be extended so as to further enhance the safety of the lighting device.

Further, according to one embodiment of the present invention, the rotational fixing element of the holder of the lighting device has an extending portion with a special structural design, such that the extending space of the end cap can be stably engaged with the extending portion of the rotational fixing element. This structural design further enhances the structural stability of the lighting device.

Moreover, according to one embodiment of the present invention, the two conductive pins of each end cap of the light tube are disposed on the two sides of the extending space of the end cap. Therefore, when the user rotates the light tube, the extending portion of the rotational fixing element embedded in the extending space provides appropriate assistance to alleviate the force applied to the two conductive pins. As a result, the conductive pins are less prone to deformation during the user's rotation of the light tube.

Furthermore, according to one embodiment of the present invention, the structural design of the mistake-proof structure in the lighting device is simple, so the lighting device can achieve desired technical effects without significantly increasing the cost thereof. Consequently, the practicality of the lighting device is significantly improved, so the lighting device can be more comprehensive in application and meet actual requirements.

It will be apparent to those skilled in the art that various modifications and variations can be made to the disclosed embodiments. It is intended that the specification and examples be considered as exemplary only, with a true scope of the present invention being indicated by the following claims and their equivalents.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A lighting device having a mistake-proof structure, comprising:
two holders, wherein each of the holders comprising a holder body, two conductive plates, a rotational fixing element, and an installation fixing element, wherein the conductive plates are disposed in the holder body, and the holder body has a top hole, a central post, and a central recess, wherein the central post is disposed in the central recess, and the rotational fixing element is rotatably connected to the central post, and has an extending portion and two through holes disposed opposite each other, wherein the rotational fixing element is rotatable to align the through holes with the top hole, and the installation fixing element passes through the top hole and the through holes; and
a light tube electrically connected to the two conductive plates and comprising a tube body and two end caps provided at two ends of the tube body, wherein the end caps are respectively disposed on the two holders, and each of the end caps has an extending space engaged with the extending portion of the rotational fixing element corresponding thereto.

2. The lighting device having the mistake-proof structure as claimed in claim 1, wherein the rotational fixing element further comprises a central hole, and the central post passes through the central hole, whereby the rotational fixing element is rotatably connected to the central post.

3. The lighting device having the mistake-proof structure as claimed in claim 1, wherein the central post comprises a central groove, and the rotational fixing element is rotatable to align the through holes with the central groove and the top hole, wherein the installation fixing element passes through the top hole, the through holes, and the central groove.

4. The lighting device having the mistake-proof structure as claimed in claim 1, wherein the extending portion is a positioning plate, a positioning block, or a positioning slope.

5. The lighting device having the mistake-proof structure as claimed in claim 1, wherein the extending space is a groove, a hole, or a recess formed by a slope.

6. The lighting device having the mistake-proof structure as claimed in claim 1, wherein each of the end caps further has two conductive pins inserted into the rotational fixing element corresponding thereto, whereby the two conductive pins contact the two conductive plates.

7. The lighting device having the mistake-proof structure as claimed in claim 1, wherein the two conductive pins are respectively disposed on two sides of the extending space.

8. The lighting device having the mistake-proof structure as claimed in claim 1, wherein the installation fixing element is a screw or a combination of a snap fastener and the screw, wherein the screw passes through the top hole and the through holes.

9. The lighting device having the mistake-proof structure as claimed in claim 1, wherein the installation fixing element comprises a fixing cap and a fixing post connected to each other, wherein the fixing post passes through the top hole and the through holes.

10. A holder having a mistake-proof structure, comprising:
a holder body having a top hole, a central post, and a central recess, wherein the central post is disposed in the central recess;
two conductive plates disposed in the holder body;
a rotational fixing element rotatably connected to the central post and having an extending portion and two through holes disposed opposite each other, wherein the rotational fixing element is rotatable to align the through holes with the top hole; and
an installation fixing element passing through the top hole and the through holes.

11. The holder having the mistake-proof structure as claimed in claim 10, wherein the rotational fixing element further comprises a central hole, and the central post passes through the central hole, whereby the rotational fixing element is rotatably connected to the central post.

12. The holder having the mistake-proof structure as claimed in claim 10, wherein the central post comprises a central groove, and the rotational fixing element is rotatable to align the through holes with the central groove and the top hole, wherein the installation fixing element passes through the top hole, the through holes, and the central groove.

13. The holder having the mistake-proof structure as claimed in claim 10, wherein the extending portion is a positioning plate, a positioning block, or a positioning slope.

14. The holder having the mistake-proof structure as claimed in claim 10, wherein the installation fixing element is a screw or a combination of a snap fastener and the screw, wherein the screw passes through the top hole and the through holes.

15. The holder having the mistake-proof structure as claimed in claim 10, wherein the installation fixing element comprises a fixing cap and a fixing post connected to each other, wherein the fixing post passes through the top hole and the through holes.
